(19) United States
(12) Patent Application Publication
(10) Pub. No.: US 2005/0043481 A1
(43) Pub. Date: Feb. 24, 2005

(54) Material consisting of at least a biodegradable polymer and cyclodextrins

(76) Inventors: Ruxandra Gref, Robinson (FR); Patrick Couvreur, Sur-Yvette (FR)

Correspondence Address: YOUNG & THOMPSON, 745 SOUTH 23RD STREET, 2ND FLOOR, ARLINGTON, VA, 22202, US

(21) Appl. No.: 10/490,417

(22) PCT Filed: Sep. 27, 2002
(86) PCT No.: PCT/FR02/03321

(30) Foreign Application Priority Data
Sep. 27, 2001 (FR) 01/12456

(51) Int. Cl. C08F 2/00

(52) U.S. Cl. 525/54.2

(57) ABSTRACT

The invention concerns a material consisting of at least a biodegradable polymer and a cyclic oligosaccharide, characterized in that at least one molecule of the oligosaccharide is grafted via a covalent bond to at least a molecule of the biodegradable polymer. The invention also concerns a method for preparing the material, the nanoparticles and microparticles derived from the material and uses thereof as biological vectors for active substances.

The present invention relates to novel materials based on biodegradable polymers and cyclic oligosaccharides, preferably cyclodextrins, particles deriving from these materials, and uses thereof as biological vectors for active principles.

The present invention relates, in particular, to the field of nanoparticle and microparticle-type vectors, and to applications thereof.

The term “nanoparticles” is commonly taken to include nanospheres as well as nanocapsules. Nanocapsules are vesicle vectors formed from an oily cavity surrounded by a polymer-type wall, while nanospheres consist of a polymer matrix that is capable of encapsulating active principles. Generally, the active products are incorporated at the level of the nanoparticles either during the process of polymerisation of the monomers from which the nanoparticles are derived, or by adsorption at the surface of the already formed nanoparticles, or during the production of the particles from preformed polymers.

Various types of nanoparticles and microparticles have already been proposed in the literature. Conventionally, they are derived from a material obtained by direct polymerisation of monomers (for example, cyanoacrylates), by cross-linking, or else they are developed from preformed polymers: poly(lactic acid) (PLA), poly(glycolic acid) (PGA), poly(ε-caprolactone) (PCL), and copolymers thereof, such as, for example poly(lactic glycolic acid)(PLGA), etc.

More recently, a new type of material has been produced by catalytic polymerisation of monomers (such as, for example, lactide or caprolactone) on cyclodextrins. Unfortunately, it is not possible to control precisely the chemical composition of this type of copolymer. All of the hydroxyl functions that are present on cyclodextrins are capable of initiating the polymerisation of the monomers. A very large number of polymer chains, of variable sizes, is thus formed in derivation from the monomer, which, on the one hand, is difficult to control, and, on the other hand, causes a disturbance of the complexation properties of the cyclodextrins. Consequently, obtaining this type of copolymer by direct polymerisation of the monomers on cyclodextrins does not allow the degrees of polymerisation and substitution to be controlled, and therefore does not allow effective synthesis reproducibility and the preparation of homogeneous samples.

In conjunction with this problem of controlling the chemical composition of the polymers, there is that of their low encapsulation capacity. Indeed, the active principle-load capacity of nanoparticles is often limited. This drawback is encountered, in particular, in the encapsulation of active principles with low water-solubility, in so far as the conventional methods for producing nanoparticles or microparticles often have recourse to polymerisation techniques in an aqueous medium.

Consequently, the materials that are currently available are not entirely satisfactory.

The first object of the present invention is, specifically, to propose a material that allows these drawbacks to be overcome.

Its second object relates to particles, preferably nanoparticles, obtained from such a material.

The invention also relates, in a third object, to the use of these particles, in particular as biological vehicles.

More precisely, the first aspect of the invention relates to a material composed of at least one biodegradable polymer and a cyclic oligosaccharide, wherein at least one molecule of said oligosaccharide is grafted via a covalent bond onto at least one molecule of said biodegradable polymer.

In contrast to the materials described above, the material developed according to the present invention has the first advantage of having a controlled structure, and therefore of being able to be prepared in a reproducible manner. The biodegradable polymer used is, in particular, characterised in terms of molar mass.

More precisely, the material claimed is obtained by functionalising the molecule of a biodegradable polymer with at least one cyclic oligosaccharide molecule.

This functionalisation is carried out by establishing a covalent bond between the two types of molecule. In such cases, this covalent bond is biodegradable and preferably derives from a reaction between a carboxylic acid function and a hydroxyl function, resulting in an ester function.

More preferably, this bond derives from the reaction between an optionally activated carboxyl function that is present on the biodegradable polymer and a hydroxyl function present on the oligosaccharide. The preferred activated derivatives of the acid are either N-hydroxysuccinimide ester, synthesised and isolated beforehand, or derivatives obtained “in situ” and not isolated from the reaction medium, such as, for example, that derived from carbonyldiimidazole (CDI). This reactive function preferably derives from the carboxyl function, which may either be naturally present on the skeleton of the biodegradable polymer or have been introduced beforehand into its skeleton, so as to facilitate its subsequent coupling to a cyclic oligosaccharide molecule.

According to a preferred embodiment of the invention, the claimed material is composed of a copolymer according to the invention that is grafted in the region of said biodegradable polymer to a second cyclic oligosaccharide molecule, a second biodegradable polymer molecule and/or a molecule distinct from said biodegradable polymer and said cyclic oligosaccharide.

FIG. 1 shows schematically structures according to the invention.

According to a first variant of the invention, the biodegradable polymer molecule is grafted, preferably in the end position, by a biodegradable covalent bond, preferably of the ester type, to at least two cyclic oligosaccharide molecules, preferably of the cyclodextrin type.

According to a second variant of the invention, the biodegradable polymer molecule is grafted by a biodegradable covalent bond, preferably of the ester type, to at least one oligosaccharide molecule, preferably of the cyclodextrin type, and a molecule of a separate polymer, preferably poly(ethyleneglycol).

As this second variant consists in fixing a second molecule or macromolecule to the free end of the biodegradable polymer, it is advantageous, in particular, if it is desired to prevent spontaneous auto-encapsulation of the hydrophobic chain of said biodegradable polymer in the cavity of the oligosaccharide, more particularly a cyclodextrin. Said cavity is thus made available for any hydrophobic active principle.

Whichever variant is considered, it is also conceivable that the graft or grafts carried by the biodegradable polymer molecule is/are also grafted by a biodegradable function, preferably of the ester type, to one or more other molecules of said biodegradable polymer, thus allowing (cross-linked) materials with a very high molar mass to be obtained.

The materials according to the invention have the second advantage of having satisfactory biodegradability, owing to the chemical nature of the polymers of which they consist.

In the sense of the invention, the term “biodegradable” shall refer to any polymer that dissolves or degrades in an acceptable period for the application for which it is intended, usually in in vivo treatment. Generally, this period must be less than five years and preferably less than one year if a corresponding physiological solution with a pH from 6 to 8 is exposed to a temperature between 25° C. and 37° C.

The biodegradable polymers according to the invention are, or derive from, synthetic or natural biodegradable polymers.

Conventionally, the synthetic biodegradable polymers used most often are the polyesters: PLA, PGA, PCL, and copolymers thereof, such as, for example, PLGA. Their biodegradability and biocompatibility have been widely established. Other synthetic polymers have also been investigated. These are polyanhydrides, poly(alkylcyanoacrylates), polyorthoesters, polyphosphazenes, polyamino acids, polyamidoamines, polysiloxane, polyesters, such as polyhydroxybutyrate or poly(malic acid), and also the copolymers and derivatives thereof. Natural biodegradable polymers (proteins, such as albumin or gelatin, or polysaccharides such as alginate, dextran or chitosan) may also be suitable.

In the case in point, synthetic polymers are particularly advantageous, as their bioerosion is observed rapidly. Commercial polymers are, however, not always appropriate for being coupled to one or more oligosaccharides, as they do not have the reactive group in question, more particularly the carboxylic acid group, above all in the case of linear biodegradable polyesters (PLA, PCL, etc.). Consequently, the coupling of these polymers to a cyclic oligosaccharide according to the present invention requires a prior synthesis of the polymers having the required reactive groups, more particularly the carboxylic acid functions, while at the same time controlling the nature of the groups that are naturally present at the chain end. These are, in particular, the compounds thus obtained that are referred to, in the terms of the present invention, as biodegradable polymer derivatives.

The biodegradable polymer thus preferably corresponds to the general formula I: 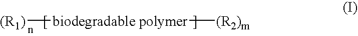
wherein:
n and m represent, independently of each other, either 0 or 1,
R₁ represents a C₁-C₂₀ alkyl group, a polymer other than the biodegradable polymer, [for example polyethylene(glycol)(PEG)], or a copolymer containing PEG blocks or ethylene oxide units [such as, for example, a Pluronic® polymer], a protected reactive function that is present on the polymer (for example, BOC—NH—), a carboxyl function or a hydroxyl function, and
R₂ represents a hydroxyl function or a carboxyl function.

The following polyesters are preferred, in particular, as biodegradable polymers according to the invention: poly(lactic acid) (PLA), poly(glycolic acid) (PGA), poly(ε-caprolactone) (PCL), and copolymers thereof, such as, for example, poly(lactic glycolic acid) (PLGA), synthetic polymers, such as polyanhydrides, poly(alkylcyanoacrylates), polyorthoesters, polyphosphazenes, polyamides (for example, polycaprolactam), polyamino acids, polyamidoamines, poly(alkylene d-tartrate), polycarbonates, polysiloxane, polyesters, such as polyhydroxybutyrate or polyhydroxyvalerate, and poly(malic acid), as well as the copolymers of these materials and derivatives thereof.

The material is more preferably a polylactic, a polyester, preferably having a molecular weight less than 5000 g/mol and, in particular, a polycaprolactone, preferably having a molecular weight between 2000 and 4000 g/mol.

The claimed material is, furthermore, particularly advantageous, owing to the presence of cyclic oligosaccharide molecules within its structure, for developing nanoparticles or microparticles having a high encapsulation capacity. The encapsulation rate is, of course, dependent on the cyclic oligosaccharide mass content.

In the sense of the present invention, the term “oligosaccharide” shall refer to a cyclic concatenation of at most 15 and preferably at most 10 monosaccharide units joined by glycoside bonds.

The cyclic oligosaccharide is preferably selected from the group comprising cyclodextrins, which may be neutral or charged, native (α, β, γ, δ, ε cyclodextrins), branched or polymerised, or else chemically modified, for example by substituting one or more hydroxyls with groups such as alkyls, aryls, arylalkyls, glycosyls, by etherification with alcohols or by esterification with aliphatic acids, as well as by grafting polymer chain links (for example, polyethylene glycol). Of the above groups, the hydoxypropyl, methyl and thiobutylether groups are preferred in particular.

These modifications must, of course, affect only a few of the groups that are present on cyclic oligosaccharides, so as to leave the vast majority of them free then to allow the coupling of the biodegradable polymers. Cyclodextrins grafted with hydrophilic chains of the poly(ethylene glycol) type have thus already been described.

The presence of at least one and preferably two cyclic oligosaccharide molecules, in particular cyclodextrins bound covalently to the hydrophobic polymer in the material according to the invention, is particularly advantageous. It allows the active principle, which is intended to be conveyed using particles deriving from the claimed material, to penetrate inside the polymeric structure of said material, whatever its nature, i.e. hydrophobic, amphiphilic and/or insoluble. This results in a significantly increased encapsulation yield, owing to the presence of the hydrophobic internal cavities of the cyclodextrins. These cavities allow the active principle load to be increased, on the one hand, and better control of the release profile to be obtained, on the other hand.

According to an advantageous embodiment of the present invention, the claimed material has a cyclic oligosaccharide, preferably cyclodextrin, mass content at least equal to 10% and advantageously between around 20 and 40%.

As well as performing advantageously in terms of biodegradability and encapsulation capacity, the material according to the invention is also particularly beneficial in terms of bioadhesion and targeting properties for the particles that derive from it, at the level of organs and/or cells.

Examples of the claimed material include, in particular, that deriving from a copolymer having a biodegradable polymer skeleton and at least two cyclodextrin grafts, optionally grafted by one or more biodegradable polymer molecules, which may or may not be of different chemical types from those of the polymer forming the skeleton of said material.

The second variant of the invention, which relates to a material composed of biodegradable polymer molecules that is grafted, on the one hand, onto a molecule of a cyclic oligosaccharide, preferably of the cyclodextrin type, and, on the other hand, onto a molecule of a different biodegradable polymer, is particularly advantageous in this regard.

According to this variant, it is conceivable to incorporate, into the structure of the material, compounds that are intended to intervene in the release profile of the active matters having to be released from the nanoparticles composed of said material.

It is also conceivable to modify the structure of the materials, for example, by grafting one or more PEG chains by an ester bond to a biodegradable polymer molecule. The particles thus covered with a PEG crown display prolonged circulation in the blood.

The copolymers forming the claimed material may be in the form of diblock or multiblock copolymers, and have a linear, branched or cross-linked structure.

The term “cross-linked” shall refer to polymers forming a three-dimensional network, in contrast to simplified linear polymers. In the three-dimensional network, the chains are connected to one another by covalent or ionic bonds and become insoluble.

Diblock or multiblock copolymers may be obtained by varying the oligosaccharide/biodegradable polymer molar ratio during synthesis. Copolymers with a cross-linked structure may be obtained from biodegradable polymers comprising at least two reactive functions.

The second aspect of the present invention relates to a method for preparing the claimed material.

More precisely, this method comprises the steps of contacting at least one molecule of a biodegradable polymer, or of one of its derivatives carrying at least one reactive function, with at least one molecule of a cyclic oligosaccharide, in conditions conducive to the formation of a covalent bond between the two types of molecules, and the recovery of said material.

Advantageously, in the case of polycaprolactone, the preparation method claimed does not require the use of a catalyst, as do the conventional methods of direct polymerisation of monomers on the skeletons of oligosaccharides or polysaccharides. This particularity of the claimed method is therefore particularly advantageous in terms of innocuousness and biodegradability of the resulting material.

According to a preferred variant of the invention, the reactive function that is present on the biodegradable polymer is an activated carboxylic acid function. Preferably, the oligosaccharide, more preferably a cyclodextrin, and the appropriately activated biodegradable polymer are brought together in a mass ratio ranging from 2:98 to 40:60.

The ester bond between the cyclic oligosaccharides and the polyesters is produced by going through an activated ester of the acid function (esterification with NHSI in the presence of dicyclohexylcarbodiimide (DCC)), which is then isolated, or by going through a non-isolated intermediate (activation via carbonyldiimidazole (CDI)). This esterification reaction falls within the ability of a person skilled in the art.

More preferably, the biodegradable polymers correspond to the definitions proposed above. In particular, they may derive from natural or synthetic biodegradable polymer molecules, which have been modified so as to be functionalised according to the present invention.

A third aspect of the invention relates to particles composed of a material according to the invention.

The claimed particles may have a size between 50 nm and 500 μm and preferably between 80 nm and 100 μm.

In fact, according to the preparation protocol reserved for preparing particles from the claimed material, the size of the particles may be fixed.

According to a preferred embodiment of the invention, the particles have a size between 1 and 1000 nm, and are therefore called nanoparticles. Particles varying in size from 1 to several thousand microns refer to microparticles.

The claimed nanoparticles or microparticles may be prepared according to methods that have already been described in the literature, such as, for example, the technique of emulsion/evaporation of the solvent [R. Gurny et al. “Development of biodegradable and injectable latices for controlled release of potent drugs”, Drug Dev. Ind. Pharm., Vol. 7, pp. 1-25, 1981]; the nanoprecipitation technique using a solvent that is miscible with water (FR 2 608 988 and EP 274 691). There are also variants of these methods. For example, the so-called “double emulsion” technique, which is advantageous for the encapsulation of hydrophilic active principles, consists in dissolving said active principles in an aqueous phase, in forming a water/oil-type emulsion with an organic phase containing the polymer, then in forming a water/oil/water-type emulsion using a new aqueous phase containing a surface-active agent. After the organic solvent has evaporated, nanospheres or microspheres are recovered.

The material according to the present invention has the major advantage, on account of its amphiphilic nature, of having surface-active properties. These properties may therefore be used advantageously during preparation of particles, for example, so as to avoid the use of surface-active agents, which are used systematically in the above-mentioned methods. Said surface-active agents are not always biocompatible and are difficult to eliminate at the end of the process.

Another advantage of the material according to the present invention is that it offers the possibility of modulating the properties involved in the particle production method, through the selection:
of the biodegradable polymer/oligosaccharide mass ratio, and/or
of the molar masses (sizes of the blocks) of the biodegradable polymer and oligosaccharides in question.

It is thus possible to obtain copolymers that are water-soluble or insoluble in water, having hydrophilic-lipophilic balances extending over a wide range, and thus allowing either water/oil or oil/water emulsions to be stabilised.

Similarly, it is conceivable that particles may be formed from mixtures of two or more types of materials according to the present invention.

Examples of the particles according to the invention include, in particular, those composed of a material deriving from a polycaprolactone or poly(lactic acid) block bound by an ester-type bond to at least one and preferably two cyclodextrin molecules.

The particle structures that are capable of being obtained from the material according to the invention and the above-mentioned methods may be variable. The following are therefore distinguished:
a biodegradable polymer hydrophobic core (capable of encapsulating active principles)/cyclic oligosaccharide hydrophilic crown-type structure, obtained either using one of the above-mentioned methods or by adsorption of the material according to the invention on preformed particles;
a structure of the particles according to which the biodegradable polymer matrix contains aqueous inclusions that may be obtained by a “double emulsion” method and adapted to the encapsulation of the hydrophilic active principles. According to the operating procedure selected and the hydrophilic-lipophilic balance of the material, the cyclic oligosaccharide may be disposed either exclusively in the region of the aqueous inclusions or in the region of these inclusions and of the surface of the particles. Certain sensitive encapsulated active principles (proteins, peptides, etc.) may thus be protected with regard to, often denaturing, interactions with the hydrophobic biodegradable polymer and the organic solvent;
a hydrophilic core (cyclic oligosaccharide)/hydrophobic crown (biodegradable polymer)-type structure if the particles are prepared from an oil-in-oil (for example, silicone-acetone oil) or water-in-oil-in-oil emulsion;
a micellar structure obtained owing to the auto-association of a material according to the invention in the aqueous phase, and
a so-called gel structure formed by the cross-linking of the oligosaccharides with biodegradable polymers comprising at least two reactive functions;
a core/crown-type structure, with a PEG (or other hydrophilic polymer) crown and a polyester and cyclic oligosaccharide mixed core.

In the case of the present invention, the particles preferably degrade over a period ranging between one hour and several weeks.

The particles according to the invention may contain an active ingredient. This ingredient may be hydrophilic, hydrophobic or amphiphilic and biologically active in nature.

Examples of biologically active principles include, in particular, peptides, proteins, carbohydrates, nucleic acids, lipids, polysaccharides, or mixtures thereof. They may also be synthetic or natural, organic or inorganic molecules, which, when administered in vivo to an animal or to a patient, are capable of inducing a biological effect and/or manifesting a therapeutic activity. They may thus be antigens, enzymes, hormones, receptors, peptides, vitamins, minerals and/or steroids.

Examples of drugs that can be incorporated into these particles include anti-inflammatory compounds, anaesthetics, chemotherapeutic agents, immunotoxins, immunosuppressive agents, steroids, antibiotics, antivirals, antifungals, antiparasitics, vaccinating substances, immunomodulators and analgesics.

Examples of drugs that may be incorporated into these particles include, in particular, molsidomine, ketoconazole, gliclazide, diclofenac, levonorgestrel, paclitaxel, hydrocortisone, pancratistatin, ketoprofen, diazepam, ibuprofen, nifedipine, testosterone, tamoxifen, furosemide, tolbutamide, chloramphenicol, benzodiazepine, naproxen, dexamethasone, diflunisal, anadamide, pilocarpine, daunorubicin, doxorubicin and diazepam.

Similarly, compounds with a diagnostic function may be incorporated into the particles. These may be substances that are detectable by X-rays, fluorescence, ultrasound, nuclear magnetic resonance or radioactivity. The particles may thus include magnetic particles, radio-opaque materials (such as, for example, air or barium) or fluorescent compounds. For example, fluorescent compounds, such as rhodamine or Nile red, may be encompassed in particles with a hydrophobic core. Alternatively gamma emitters (for example, indium or technetium) may be incorporated therein. Hydrophilic fluorescent compounds may also be encapsulated in the particles, but with a lower yield in comparison to hydrophobic compounds, owing to the lesser affinity with the matrix.

Commercially available magnetic particles having controlled surface properties may also be incorporated into the matrix of the particles or attached covalently to one of their constituents.

The active matter may be incorporated into these particles during their formation process or else be fed at the level of the particles, once these have been obtained.

The particles according to the invention may comprise up to 95% by weight of an active principle.

The active principle may thus be present in a quantity varying from 0.001 to 990 mg/g of particle and preferably from 0.1 to 500 mg/g. It should be noted that, in the case of encapsulation of certain macromolecular compounds (DNA, oligonucleotides, proteins, peptides, etc.), even weaker loads may be sufficient.

The particles according to the invention may be administered in different ways, for example via the oral, parenteral, ocular, pulmonary, nasal, vaginal, cutaneous and buccal routes, etc. The oral route, which is non-invasive, is a preferred route.

Generally, orally administered particles may undergo various processes: translocation (capture, then passage through the digestive epithelium by the intact particles), bioadhesion (immobilisation of the particles at the surface of the mucous membrane by an adhesion mechanism), and transit. In these first two phenomena, the surface properties play a major role. Advantageously, the particles further comprise at least one molecule bound covalently or non-covalently to their surface.

The fact that certain particles according to the invention have numerous free hydroxyl functions at the surface proves particularly advantageous for binding a biologically active molecule that has a targeting role or that is detectable. It is thus conceivable that the surface of these particles may be functionalised, so as to modify their surface properties and/or target them more specifically toward certain tissues or organs. The particles thus functionalised may optionally be maintained at the level of the target by use of a magnetic field, during medical imaging or during the release of an active compound. Similarly, ligands of the targeting molecule-type, such as receptors, lectins, antibodies or fragments thereof, may be fixed at the surface of the particles. This type of functionalization falls within the ability of a person skilled in the art.

Generally, these ligands or molecules are coupled to the surface of the particles either covalently, by attaching the ligand to the oligosaccharide covering the particles, or non-covalently, i.e. by affinity. Certain lectins may therefore be attached by specific affinity to oligosaccharides located at the surface of the particles according to the present invention, thus enhancing the cellular recognition properties of these particles. For this type of application, it would be advantageous to functionalise the materials according to the present invention, by grafting sugar residues at the level of the cyclic oligosaccharides. It may also be advantageous to graft the ligand by means of a spacer arm, in order to allow it to reach its target in an optimal conformation. Alternatively, the ligand may be carried by another polymer entering the composition of the particles. This aspect has been described above.

The invention also relates to the use of the particles obtained according to the invention for encapsulating one or more active principles as defined above.

Another aspect of the invention also relates to pharmaceutical or diagnostic compositions comprising particles of the invention, preferably associated with at least one pharmaceutically acceptable and compatible vehicle. The particles may, for example, be administered in gastro-resistant capsules or be incorporated into gels, implants or tablets. They may also be prepared directly in an oil (such as Migliol®), and this suspension be administered in a capsule or be injected at a precise site (for example, a tumor).

These particles may, in particular, be used as stealth vectors, i.e. they are capable of evading the immune defence system of the organism, and/or as bioadhesive vectors.

The examples and figures appearing below are given by way of a non-limiting illustration of the present invention.

### FIGURES

FIG. 1: schematic representations of various conformational structures of the materials according to the invention.

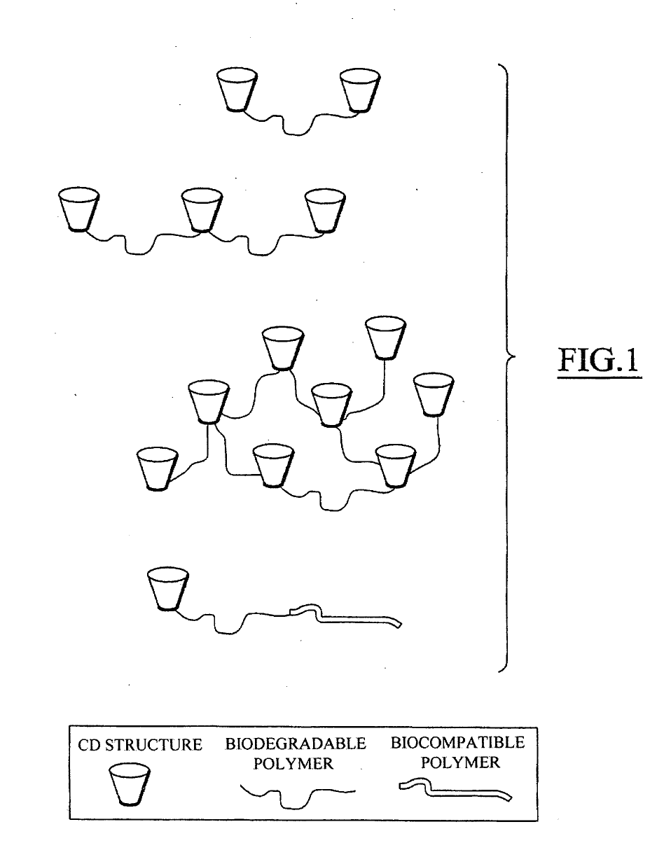

FIG. 2: chromatogram of the product of the reaction of β cyclodextrin with the polyester PCL-diacid (HO₂C-PCL-CO₂H).

### EXAMPLES

### Example 1

Synthesis of R-PCL-COOH (R=C₉H₁₉)

Monofunctionalized PCL polymers of the R-PCL-CO₂H (R=C₉H₁₉) type, with a molar mass varying from 2000 to 5000 g/mol, were obtained from 3.2 g of monomer (freshly distilled ε-caprolactone) and 0.3 g of high-purity capric acid (C₉H₁₉CO₂H). The acid and the ε-caprolactone were introduced into a round-bottomed flask topped by an ascending cooler. After stringent purging of the reagents, the round-bottomed flask was introduced into an oil bath heated to 235° C. The reaction took place for 6½ hours under an inert atmosphere (argon). It was stopped by immersing the round-bottomed flask in ice. The obtained solid was dissolved under heat under 15 ml THF, then precipitated at ambient temperature with cold methanol.

After three successive precipitations, the yield by weight of the reaction was 60 to 70%. The average molar masses by number (Mn) and by weight (Mw) were determined by steric exclusion chromatography (SEC) (eluting THF 1 ml/min, universal calibration carried out with polystyrene standards). Mn was equal to 3420 g/mol and Mw to 4890 g/mol; the polydispersity index was therefore equal to 1.4.

An average molar mass by number equal to 3200 g/mol was determined by titrating polymer samples of approximately 100 mg, dissolved in an acetone-water mixture, with a KOH/EtOH 10⁻² M solution.

### Example 2

Synthesis of HOOC-PCL-COOH

The bifunctionalised HOOC-PCL-COOH polymer was synthesised according to the operating procedure of example 1.

Succhinic acid (99.9%, Aldrich), used as an initiator, was dried under vacuum at 110° C. for 24 hours. The monomer (ε-caprolactone) was freshly purified by distillation over calcium hydride under low pressure.

The polymerisation from 0.2 g of succhinic acid and 4 g of ε-caprolactone allowed 3.2 g of polymer to be obtained after 3 hours of reaction (76% yield by weight after 4 successive precipitations).

Mixing KOH/EtOH 10⁻² M with the terminal COOH groups allowed an acidity corresponding to a molar mass corresponding to a molar mass of 3500 g/mol to be determined.

By SEC, Mn is equal to 4060 g/mol and Mw to 4810 g/mol, and the polydispersity index is 1.2.

### Example 3

Synthesis of βCD-PCL-βCD

3 g of HO₂C-PCL-CO₂H obtained according to example 2 were rendered anhydrous by azeotropic distillation, then dried under vacuum in a 50 ml round-bottomed flask. The round-bottomed flask was then provided with an ascending cooler and connected to a vacuum/argon manifold. 5 ml of anhydrous THF were added into the round-bottomed flask and, after the polymer had dissolved, 0.304 g carbonyldiimidazole (CDI) were added, and the mixture was brought to reflux of THF. An emission of CO₂ was observed. It diminished after 2 hours. The reaction was stopped after 3 hours, the THF was evaporated, and 2.92 g of anhydrous βCD, dissolved in 25 ml of anhydrous DMSO, were added. All of this was heated to 140° C. under argon for 3 hours. The DMSO was evaporated and the untreated reaction product dissolved in 500 ml of chloroform. This solution was introduced into a 2 litre decanting funnel and stirred with 1 litre of water. After decantation, the aqueous phase was in the form of a stable emulsion. This emulsion was broken by Rotovap® evaporation. The polymer was obtained in the form of a precipitate. Subsequently, this precipitate was washed again with water, then recovered by filtration, washed with ether and dried. The yield was 75% by weight.

The copolymer was characterised by gel permeation chromatography (refractometric and viscosimetric detectors), using a Visco gel column (GMHHR-N, Viscotek, GB, heated to 60° C.), calibrated with polystyrene standards (universal calibration). The copolymer was dissolved in N,N-dimethyl acetamide (DMAC), in a concentration of 5 mg/ml. The volume injected was 100 μl. The eluent was DMAC containing 0.5% lithium bromide, at a flow rate of 0.5 ml/min.

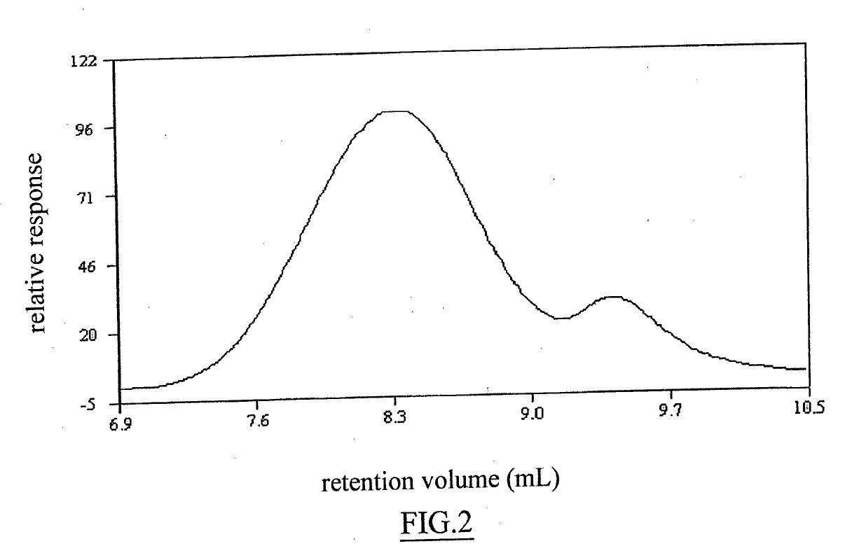

The chromatogram (FIG. 2) showed that it was a single product, with some traces of non-reacted βCD. The average molar mass by number was 8330 g/mol and the average molar mass by weight was 10790 g/mol.

This copolymer contained approximately 35% by weight βCD.

### Example 4

Incorporation of Tamoxifen

All of the glassware and equipment in contact with the tamoxifen had been coated with silicone beforehand.

A 20 μg/ml tamoxifen solution was prepared from base tamoxifen (Sigma, France) and tritiated tamoxifen (80 Ci/mol specific activity, 5.2 mCi/ml ethanol solution, Perkin Elmer, EU), so as to obtain a ³H tamoxifen/base tamoxifen isotopic dilution equal to 1/170,000 (mol/mol).

For this purpose, the base (powder) and tritiated (ethanol solution) tamoxifens were placed in solution in a minimal volume of ethanol. The ethanol was then evaporated under nitrogen flow. The residue thus obtained was placed in solution in ultrapure (Milli-Q) water, with stirring, at ambient temperature for 18 hours.

10 ml of this solution was introduced into a pill box containing 10 mg of copolymer of Example 3, in the form of fine powder. The suspension was kept at ambient temperature, with stirring, for 48 hours. The polymer was separated from the supernatant by centrifugation at 30,000 rpm for 30 min (Beckman L7-55 Ultracentrifuge, EU).

Radioactivity in the supernatant was determined by liquid scintillation counting of the tritiated tamoxifen (Beckman LS-6000-TA counter, EU). For this purpose, 200 μl of surfactant were mixed with 4 ml of Ultimagold™ scintillation liquid (Packard, The Netherlands). For each of the two samples prepared, two independent measurements were taken and the average of the four measurements was calculated. The radioactivity in the supernatants corresponds to a tamoxifen concentration of 6.25±0.13 μg/ml.

Two controls (pill boxes containing tamoxifen solutions, in the absence of polymer) were subjected to the same treatment. The residual radioactivity in the supernatants corresponded to a tamoxifen concentration 13.26±0.54 μg/ml.

By substraction, 70 μg, in total, of tamoxifen were incorporated into the copolymer. This corresponds to 7 μg of tamoxifen/mg of copolymer.

It will be noted that the material according to the invention facilitates the incorporation of a high quantity of tamoxifen, which is a particularly difficult compound to incorporate. It will also be remarked that the radioactivity values measured in the supernatants of the two samples taken are very close, which shows that the incorporation into the material according to the invention is carried out in a reproducible manner.

1-41. (cancelled)

42. Material composed of at least one biodegradable polymer and a cyclic oligosaccharide, wherein at least one molecule of said oligosaccharide is grafted via a covalent bond to at least one molecule of said biodegradable polymer.

43. Material according to claim 42, wherein a second cyclic oligosaccharide molecule, a second molecule of said biodegradable polymer and/or a molecule different from said biodegradable polymer and said cyclic oligosaccharide are also grafted by a covalent bond in the region of said biodegradable polymer.

44. Material according to claim 42, wherein the covalent bond established between the biodegradable polymer molecule and the other molecule or molecules is an ester-type bond.

45. Material according to claim 44, wherein the covalent bond derives from the reaction between an activated or non-activated carboxyl function that is present on the molecule of the biodegradable polymer and a hydroxyl function that is present on the grafted molecule.

46. Material according to claim 42, wherein the biodegradable polymer corresponds to the formula (I): 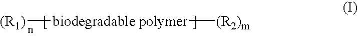
wherein:
n and m, independently of each other, represent either 0 or 1,
R₁ represents a C₁-C₂₀ alkyl group, a polymer other than the biodegradable polymer, or a copolymer containing PEG blocks or ethylene oxide units, a protected reactive function that is present on the polymer, a carboxyl function or a hydroxyl function, and
R₂ represents a hydroxyl function or a carboxyl function.

47. Material according to claim 42, wherein the biodegradable polymer is selected from poly(lactic acid) (PLA), poly(glycolic acid) (PGA), poly(s-caprolactone) (PCL), synthetic polymers, such as polyanhydrides, poly(alkylcyanoacrylates), polyorthoesters, polyphosphazenes, polyamides, polyamino acids, polyamidoamines, poly(alkylene d-tartrate), polycarbonates, polysiloxane, polyesters or poly(malic acid), and also the copolymers and derivatives thereof.

48. Material according to claim 42, wherein the biodegradable polymer is a polyester having a molecular weight less than 50.000 g/mol.

49. Material according to claim 42, wherein the biodegradable polymer is a polycaprolactone.

50. Material according to claim 42, wherein the cyclic oligosaccharide is a cyclodextrin.

51. Material according to claim 50, wherein the biodegradable polymer is grafted to at least two cyclodextrin molecules.

52. Material according to claim 42, wherein said material has a biodegradable polymer skeleton and at least two cyclodextrin grafts, optionally grafted by one or more biodegradable polymer molecules, which may or may not be different from those of the polymer forming the skeleton of said material.

53. Material according to claim 50, wherein said biodegradable polymer is grafted to at least one cyclodextrin molecule and a molecule of a different polymer.

54. Material according to claim 53, wherein the different polymer is a polyethylene glycol.

55. Material according to claim 50, wherein said material has a cyclic oligosaccharide mass content at least equal to 10%.

56. Material according to claim 50, wherein said material has a cyclic oligosaccharide mass content of between 20 and 40% by weight.

57. Material according to claim 42, wherein the cyclic oligosaccharide is a cyclodextrin with a linear, branched or cross-linked structure.

58. Material according to claim 42, wherein the cyclic oligosaccharide is a cyclodextrin and the biodegradable polymer is selected from the group comprising polycaprolactone, a polyester and polylactic acid.

59. Material according to claim 43, wherein the cyclic oligosaccharide is a cyclodextrin and the biodegradable polymer is selected from the group comprising polycaprolactone, a polyester and polylactic acid.

60. Method for preparing a material according to claim 42, comprising the step of contacting at least one molecule of a biodegradable polymer, or one of its derivatives carrying at least one reactive function with at least one molecule of a cyclic oligosaccharide in conditions that are favorable for forming a covalent bond between the two types of molecules, and of recovering said material.

61. Method according to claim 60, wherein the biodegradable polymer corresponds to the formula (I): 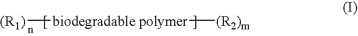
wherein:
n and m, independently of each other, represent either 0 or 1,
R₁ represents a C₁-C₂₀alkyl group, a polymer other than the biodegradable polymer, or a copolymer containing PEG blocks or ethylene oxide units, a protected reactive function that is present on the polymer, a carboxyl function or a hydroxyl function, and
R₂ represents a hydroxyl function or a carboxyl function.

62. Method according to claim 60, wherein the reactive function of the biodegradable polymer is an activated carboxylic acid function.

63. Method according to claim 60, wherein the cyclic polysaccharide is a cyclodextrin.

64. Method according to claim 63, wherein the cyclodextrin and the biodegradable polymer are contacted in a mass ratio ranging from 2:98 to 40:60.

65. Particle obtained from a material according to claim 42.

66. Particle according to claim 65, wherein it is composed of a material deriving from at least one polycaprolactone or poly(lactic acid) molecule, bound by an ester-type bond to one, preferably at least two, cyclodextrin molecule or molecules.

67. Particle according to claim 66, wherein it is a nanoparticle.

68. Particle according to claim 66, wherein it is a microparticle.

69. Particle according to claim 65, further comprising an active principle.

70. Particle according to claim 69, wherein the active principle is selected from the group comprising peptides, proteins, carbohydrates, nucleic acids, lipids, polysaccharides or organic and inorganic molecules that are capable of inducing a biological effect and/or manifesting a therapeutic activity.

71. Particle according to claim 69, wherein the active principle is selected from the group comprising molsidomine, ketoconazole, gliclazide, diclofenac, levonorgestrel, paclitaxel, hydrocortisone, pancratistatin, ketoprofen, diazepam, ibuprofen, nifedipine, testosterone, tamoxifen, furosemide, tolbutamide, chloramphenicol, benzodiazepine, naproxen, dexamethasone, diflunisal, anadamide, pilocarpine, daunorubicin, doxorubicin and diazepam.

72. Particle according to claim 69, comprising up to 95% by weight of active principle.

73. Particle according to claim 65, further comprising at least one molecule bound covalently to its surface.

74. Particle according to claim 65, further comprising at least one molecule bound non-covalently to its surface.

75. Particle according to claim 73, wherein said molecule is a biologically active molecule, a molecule with a targeting role or a molecule that is capable of being detected.

76. Particle according to claim 74, wherein said molecule is a biologically active molecule, a molecule with a targeting role or a molecule that is capable of being detected.

77. Particle according to claim 75, wherein the targeting molecule is selected from the group comprising receptors, antibodies, antibody fragments and lectins.

78. Particle according to claim 76, wherein the targeting molecule is selected from the group comprising receptors, antibodies, antibody fragments and lectins.

79. Method for the administration of an active principle, comprising the use of particles according to claim 69.

80. Method according to claim 79, wherein the active principle is selected from the group comprising peptides, proteins, carbohydrates, nucleic acids, lipids, or organic or inorganic molecules that are capable of inducing a biological effect and/or with therapeutic activity.

81. Pharmaceutical composition, comprising particles according to claim 65.

82. Diagnostic composition, comprising particles according to claim 65.
